(19) United States
(12) Patent Application Publication
(10) Pub. No.: US 2012/0279258 A1
(43) Pub. Date: Nov. 8, 2012

(54) METHOD OF DEHYDRATING AND SINTERING POROUS PREFORM FOR OPTICAL FIBER AND DEHYDRATION-SINTERING FURNACE

(75) Inventors: Yoshinori ISHIDA, Tokyo (JP); Seiichi Shinada, Tokyo (JP); Mitsuhiro Kawasaki, Tokyo (JP)

(73) Assignee: THE FURUKAWA ELECTRIC CO., LTD., Chiyoda-ku (JP)

(21) Appl. No.: 13/555,561

(22) Filed: Jul. 23, 2012

Related U.S. Application Data
(62) Division of application No. 11/678,381, filed on Feb. 23, 2007.

(51) Int. Cl. C03B 37/07

(52) U.S. Cl. 65/379

(57) ABSTRACT

A dehydration-sintering furnace includes a muffle tube that accommodates therein the porous preform, a heater that heats the porous preform from outside of the muffle tube, a furnace body that accommodates the heater at an outer periphery of the muffle tube. When a gas required for dehydrating and sintering the porous preform is supplied in the muffle tube, and a pressure in the muffle tube is measured, an average value of the pressure in the muffle tube P0 and a standard deviation of the pressure in the muffle tube σ0 are controlled to satisfy a relation P0−3×σ0>0.

### CROSS-REFERENCE TO RELATED APPLICATIONS

This application is a divisional of U.S. Ser. No. 11/678,381 filed Feb. 23, 2007, the entire contents of which is incorporated herein by reference. Japanese Patent Application No. 2005-213491 filed Jul. 22, 2005 is a prior foreign application.

### BACKGROUND OF THE INVENTION

1. Field of the Invention

The present invention relates to a technology for dehydrating and sintering a porous preform for an optical fiber.

2. Description of the Related Art

A method of manufacturing a porous preform for an optical fiber is known, in which, when a porous preform is sintered, inert gas required for sintering, such as helium gas, is supplied in a muffle tube accommodated an electric furnace to set a pressure inside the muffle tube higher than a pressure thereabout and sintering of the porous preform is performed (see, for example, Japanese Patent Application Laid-open No. S60-46938).

Since the inert gas is heated at a high temperature portion in the muffle tube to expand rapidly, a local pressure fluctuation occurs in the muffle tube. Accordingly, a periodic pressure fluctuation occurs in the muffle tube, and the pressure in the muffle tube instantaneously lowers. This can result in a state that the pressure in the muffle tube lowers equal to or below the atmospheric pressure. In this case, air can be mixed into the muffle tube during hydration and sintering of the porous preform. Therefore, OH loss of an obtained optical fiber near 1.38 micrometers is increased by moisture in the air, which results in a major obstacle to an optical fiber for wide transmission band. Therefore, a hydration sintering method, in which a flow rate of gas flowing in the muffle tube is increased to several tens of liters/minute (L/m), so that even if the pressure fluctuation occurs, the pressure in the muffle tube is prevented from lowering to equal to or below the atmospheric pressure, is utilized for preventing air from being mixed into the muffle tube.

This method is effective for preventing air from being mixed into the muffle tube during dehydration and sintering, however, the flow velocity becomes faster according to increase of the flow rate of gas, and vibrations are applied to the porous preform, which can result in that the porous preform is partially chipped off or cracks occur on a surface of the porous preform. In addition, dehydration and sintering are not economical under a condition where a flow rate of gas is high.

There has been disclosed a dehydration-sintering furnace for an optical fiber preform for performing dehydration and sintering in a state that a pressure fluctuation absorbing container for absorbing pressure fluctuations in the muffle tube is connected to the muffle tube to reduce the pressure fluctuations in the muffle tube (see, for example, Japanese Patent Application Laid-open No. H6-127964).

However, even if such a dehydration-sintering furnace is used, pressure fluctuations may not be reduced when a capacity of the pressure fluctuation absorbing container is inappropriate. This can result in a state where a pressure in the muffle tube lowers equal to or less than the atmospheric pressure. Unless a relationship among the capacity of the pressure fluctuation absorbing container, the pressure in the muffle tube, and pressure fluctuations in the muffle tube is grasped, increase in the apparatus cost or waste of space utility can occur due to attachment of a pressure fluctuation absorbing container with an excessive capacity.

### SUMMARY OF THE INVENTION

It is an object of the present invention to at least partially solve the problems in the conventional technology.

A method according to one aspect of the present invention is for dehydrating and sintering a porous preform for an optical fiber using a dehydration-sintering furnace that includes a muffle tube that accommodates therein the porous preform, a heater that heats the porous preform from outside of the muffle tube, and a furnace body that accommodates the heater at an outer periphery of the muffle tube. The method includes supplying a gas required for dehydrating and sintering the porous preform in the muffle tube; measuring a pressure in the muffle tube; and controlling an average value of the pressure in the muffle tube P0 and a standard deviation of the pressure in the muffle tube σ0 so that a relation P0−3×σ0>0 is satisfied.

A dehydration-sintering furnace according to another aspect of the present invention is for dehydrating and sintering a porous preform for an optical fiber. The dehydration-sintering furnace includes a muffle tube that accommodates therein the porous preform; a heater that heats the porous preform from outside of the muffle tube; a furnace body that accommodates the heater at an outer periphery of the muffle tube; a gas supplying unit that supplies a gas required for dehydrating and sintering the porous preform in the muffle tube; and a pressure measuring unit that measures a pressure in the muffle tube. A pressure fluctuation absorbing container is connected to the muffle tube, and a capacity of the pressure fluctuation absorbing container is larger than a capacity of the muffle tube.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic cross section for explaining a dehydration-sintering furnace according to an embodiment of the present invention, which is used for a method of dehydrating and sintering a porous preform;

FIG. 2 is a graph of an example of pressure fluctuations in the dehydration-sintering furnace; and

FIG. 3 is a graph of a relationship between a pressure fluctuation absorbing container and pressure fluctuations for respective gas flow rates.

### DETAILED DESCRIPTION OF THE PREFERRED EMBODIMENTS

Exemplary embodiments of the present invention will be explained below in detail with reference to the accompanying drawings.

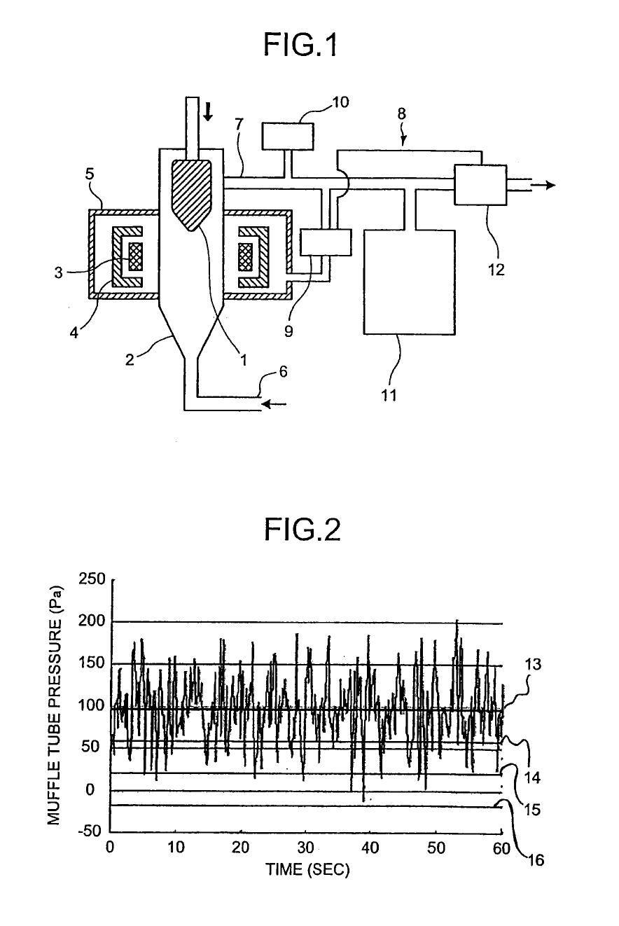

FIG. 1 is a schematic for explaining an example of a dehydration-sintering furnace of a porous preform for an optical fiber according to an embodiment of the present invention. The dehydration-sintering furnace includes a muffle tube 2 that is made of fused quartz and accommodates a porous preform 1 for an optical fiber to be dehydrated and sintered, a heater 3 that heats the porous preform 1 from the outside of the muffle tube 2, and a furnace body 5 that accommodates the heater 3 via an insulator 4 on an outer periphery of the muffle tube 2.

The porous preform 1 is introduced into the muffle tube 2 from the upper side by a conveying mechanism (not shown). The porous preform 1 is heated and dehydrated or sintered while descending slowly along the muffle tube.

Inert gas such as helium gas and dehydrating gas including halogen such as chlorine that are required for dehydration and sintering are supplied to the muffle tube 2 from a gas supplying port 6 provided at a lower portion of the muffle tube 2. A gas exhaust port 7 is provided at an upper portion of the muffle tube 2.

A predetermined amount of inert gas such as nitrogen is supplied into the furnace body 5 from a gas supplying port (not shown), so that pressure in the furnace body 5 is kept higher than the atmospheric pressure. This configuration prevents corrosion or waste of the heater due to moisture contained in external air or the like.

The dehydration-sintering furnace of a porous preform for an optical fiber includes a pressure gauge 10 that measures pressure in the muffle tube 2. The pressure gauge 10 detects whether external air is mixed in the muffle tube 2 due to lowering of pressure in the muffle tube 2 equal to or below the atmospheric pressure.

Dehydration and sintering are generally performed for preventing external air being mixed into the muffle tube 2 and for preventing deformation of the muffle tube 2, while the pressure in the muffle tube 2 is kept slightly higher than the pressure in the furnace body 5. That is, dehydration and sintering are performed in a condition that satisfies the relationship of “external pressure<pressure in the furnace body 5<pressure in the muffle tube 2”.

It is preferable that a pressure control unit 8 that controls a pressure difference is provided to maintain an appropriate pressure difference. The pressure control unit 8 includes a pressure gauge 9 that measures a pressure difference between the inside of the muffle tube 2 and the inside of the furnace body 5, and a pressure control device 12 that includes a valve for controlling an amount of gas exhausted from the gas exhaust port 7 of the muffle tube 2 when a pressure difference measured by the pressure gauge 9 reaches equal to or higher than a predetermined value.

In the dehydration-sintering furnace, the muffle tube 2 reaches a very high temperature due to heating performed by the heater 3 to be softened. At this time, according to increase in pressure difference between the inside of the muffle tube 2 and the inside of the furnace body 5 in the conventional dehydration-sintering furnace, there is a risk that the muffle tube 2 is deformed, collapsed, or holes are made in some cases. In the method of the present invention, it is necessary to control the pressure in the muffle tube 2 to be higher than that in the furnace body 5 by a fixed pressure value to prevent the above problems. In one embodiment of the present invention, the pressure difference between the inside of the muffle tube 2 and the inside of the furnace body 5 is controlled by measuring the pressure difference between the inside of the muffle tube 2 and the inside of the furnace body 5 using the pressure gauge 9 to change an opening degree of the valve in the pressure control device 12 according to the measured pressure difference. Since a pressure fluctuation in the furnace body 5 is minute, the pressure in the muffle tube 2 is substantially controlled, and at the same time, the condition that satisfies the relationship of “external pressure<pressure in the furnace body 5<pressure in the muffle tube 2” can be maintained more reliably by controlling the pressure difference between the inside of the muffle tube 2 and the inside of the furnace body 5.

In the conventional dehydration-sintering furnace, the muffle tube 2 is deformed in some cases due to a pressure fluctuation in the muffle tube 2 in short periods caused by inflation of gas in the muffle tube 2 or the like. When the porous preform 1 with a predetermined outer diameter is inserted in the muffle tube 2 in a state that the muffle tube 2 has collapsed inwardly, it contacts with the muffle tube 2, which can result in producing a defect product. When the muffle tube 2 has been expanded outwardly, holes can be made due to a contact thereof with the heater 3. When the pressure in the muffle tube 2 lowers equal to or below the atmospheric pressure, external air can be mixed in the muffle tube 2. To solve these problems, in the method of the present invention, a short periodic pressure fluctuation in the muffle tube 2 is absorbed by a pressure fluctuation absorbing container 11 provided in a piping system connected to the gas exhaust port 7.

In FIG. 1, the pressure fluctuation absorbing container 11 is made of polyvinyl chloride or Teflon® as a container whose shape does not change due to pressure fluctuations.

While it is preferable that the pressure fluctuation absorbing container 11 is a container whose shape changes due to pressure fluctuations, sufficient effects can be expected even by using a container whose shape does not change due to pressure fluctuations shown in FIG. 1. When a container whose shape does not change is used, the pressure control device can be advantageously simplified.

That is, in the dehydration-sintering furnace of a porous preform used in this embodiment, a large pressure difference between the inside of the muffle tube 2 and the inside of the furnace body 5 is adjusted by the pressure control device 12 that includes the valve, and a short periodic pressure fluctuation is absorbed by the pressure fluctuation absorbing container 11.

A method of dehydrating and sintering a porous preform according to one embodiment of the present invention that can be implemented using the dehydration and sintering apparatus shown in FIG. 1 is explained below.

First, the porous preform 1 for an optical fiber is accommodated in the muffle tube 2, gas required for dehydration and sintering such as helium or chlorine is supplied from the gas supplying port 6 into the muffle tube 2 by a fixed amount (for example, 20 L/m to 100 L/m), and heating is conducted by the heater 3 accommodated in the furnace body 5 while a pressure difference between the inside of the muffle tube 2 and the inside of the furnace body 5 is controlled by the pressure control unit 8, so that the porous preform 1 is dehydrated and sintered at a temperature at which a porous preform is sintered (for example, 1200° C. to 1500° C.).

In the present invention, pressure fluctuations in the muffle tube are controlled during a dehydration and sintering treatment in the following manner. That is, the pressure in the muffle tube is intermittently measured by the pressure gauge 10 at intervals of 0.1 second. When the measured values are represented as P1, P2, . . . Pn, an average value of the measured values for 5 minutes is represented as P0, and a standard deviation is represented as σ0, the pressure difference between the inside of the muffle tube 2 and the inside of the furnace body 5 is set and controlled to satisfy P0−3×σ0>0.

σ0={square root over ((Σ((Pn−P0)²)/(n−1))}

The standard deviation σ0 is defined as a pressure fluctuation value.

In FIG. 1, the muffle tube 2 with a fixed capacity (for example, 250 liters) and the pressure fluctuation absorbing container 11 (with a capacity of 450 liters, for example) are provided. Helium is supplied at a fixed flow rate (for example, 70 L/m) and a temperature in the muffle tube 2 is set to be a temperature at which a porous preform is sintered (for example, 1500° C.). The pressure fluctuation between the inside of the muffle tube 2 and the inside of the furnace body 5 is adjusted by the pressure control unit 8 provided in the piping system of the gas exhaust port 7, and a pressure value in the muffle tube is measured by the pressure gauge 10.

FIG. 2 is a graph of an example of pressure fluctuations in the muffle tube. In FIG. 2, a vertical axis represents a pressure in the muffle tube (gauge pressure, Pa) and a horizontal axis represents time (seconds).

As shown in FIG. 2, it is understood that the pressure in the muffle tube is largely fluctuated and a state that pressure is lower than the atmospheric pressure (a negative pressure state) occurs in the muffle tube instantaneously. This is because a short periodic pressure fluctuation in the muffle tube cannot be controlled by the pressure control unit 8. External air can be mixed in the muffle tube due to such a negative pressure. In this case, OH loss of an optical fiber near 1.38 micrometers is increased due to moisture in the air, which results in a major obstacle to an optical fiber for wide transmission band. Accordingly, it is set such that the pressure in the muffle tube does not reach a negative pressure.

That is, a relationship between the pressure in the muffle tube and the pressure fluctuation has to be set to satisfy P0−3×σ0>0. In FIG. 2, a line shown by reference numeral 13 indicates an average value P0 of the pressure in the muffle tube. In FIG. 2, reference numeral 14 indicates a straight line representing the pressure average value P0−the standard deviation σ0, and reference numerals 15 and 16 indicate straight lines representing P0−2×σ0 and P0−3×σ0.

In FIG. 2, the average value P0 of pressures in the muffle tube is set to 100 pascals, and it is preferable that P0 to be equal to or less than 400 pascals. When P0 is excessively large, the load to glass parts for maintaining air tightness for preventing atmosphere in the furnace from leaking to the outside of the muffle tube increases, which results in deterioration of economic efficiency.

In the method of the present invention, as described above, the pressure in the muffle tube is measured by the pressure gauge 10 and the pressure in the muffle tube is adjusted to satisfy P0−3×σ0>0, according to the measurement result.

In the method of the present invention, it is preferable that the pressure fluctuation absorbing container 11 has a capacity larger than that of the muffle tube 2.

A flow rate of gas from the gas supplying port 6 can be a small flow rate, for example 10 L/m to 30 L/m, under the condition of the present invention described above.

Examples of a method of dehydrating and sintering a porous preform according to the present invention will be explained in detail below.

Dehydration and sintering were performed using the dehydration-sintering furnace of a porous preform for an optical fiber shown in FIG. 1, under the pressure fluctuation condition P0−3×σ0>0 defined above.

The porous preform 1 for an optical fiber was accommodated in the muffle tube 2 (a muffle tube capacity of 250 liters), helium gas was supplied from the gas supplying port 6 to the muffle tube 2 by a fixed amount (20 L/m), and control was performed by the pressure control device 12 such that the average value of pressures in the muffle tube measured by the pressure gauge 10 was to be approximately 200 pascals. The porous preform 1 for an optical fiber was heated by the heater 3 accommodated in the furnace body 5 and it was dehydrated and sintered at a temperature of 1500° C.

First, a pressure fluctuation value was calculated in a state that the pressure fluctuation absorbing container 11 was not connected. Subsequently, the pressure fluctuation absorbing containers 11 with different capacities (450 liters and 800 liters) were prepared, each of the pressure fluctuation absorbing containers 11 was connected between the gas exhaust port 7 and the pressure control device 12, and a pressure fluctuation value of each capacity was calculated.

Similarly, dehydration and sintering were performed and a pressure fluctuation value was calculated while a helium flow rate was changed in a range of 10 L/m to 70 L/m, specifically, the rate was changed to 10 L/m, 30 L/m, 50 L/m, and 70 L/m. It was set such that the average value of pressures in the muffle tube was approximately 200 pascals in each case.

Dehydration and sintering were performed using the dehydration-sintering furnace of a porous preform for an optical fiber shown in FIG. 1, under the pressure fluctuation condition P0−3×σ0>0 defined above.

The porous preform 1 for an optical fiber was accommodated in the muffle tube 2 (a muffle tube capacity of 250 liters), helium gas was supplied from the gas supplying port 6 to the muffle tube 2 at a fixed flow rate (30 L/m), adjustment was performed such that the average value of pressures in the muffle tube measured by the pressure gauge 10 was approximately 200 pascals, and heating was started. Control was not performed by the pressure control device 12. The porous preform 1 for optical fiber was heated by the heater 3 accommodated in the furnace body 5 and it was dehydrated and sintered at a temperature of 1500° C.

First, the pressure fluctuation value was calculated in a non-connected state of the pressure fluctuation absorbing container 11. The pressure fluctuation absorbing container 11 (400 liters) different in capacity from the pressure fluctuation absorbing container 11 was then prepared, and it was connected between the gas exhaust port 7 and the pressure control device 12. The pressure fluctuation values were then calculated with regard to the respective capacities.

Dehydration and sintering were then performed in a state that the helium flow rate was changed to 70 L/m and the pressure fluctuation value was calculated. The average value of pressures in the muffle tube was set to approximately 200 pascals in this case.

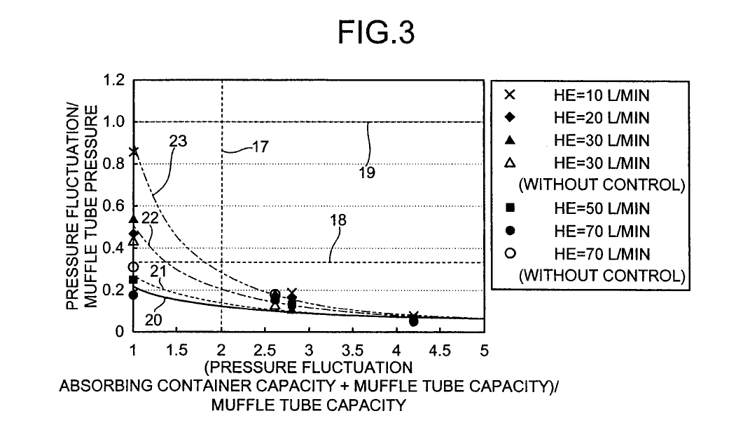

FIG. 3 is a graph of a relationship between a capacity of a pressure fluctuation absorbing container and pressure fluctuations for the respective gas flow rates obtained.

In FIG. 3, a horizontal axis represents “(pressure fluctuation absorbing container capacity+muffle tube capacity)/muffle tube capacity”, where a straight line shown by reference numeral 17 indicates, for example, a state that the pressure fluctuation absorbing container and the muffle tube have the same capacity, that is, “(pressure fluctuation absorbing container capacity +muffle tube capacity)/muffle tube capacity=2”.

When the pressure fluctuation absorbing container is not connected, “(pressure fluctuation absorbing container capacity+muffle tube capacity)/muffle tube capacity=1” is established, and when the capacity of the pressure fluctuation absorbing container is larger than that of the muffle tube, “(pressure fluctuation absorbing container capacity+muffle tube capacity)/muffle tube capacity>2” is established.

In FIG. 3, the vertical axis indicates “pressure fluctuation value σ0/average muffle tube pressure P0”. For example, a straight line shown by reference numeral 18 in FIG. 3 indicates σ0/P0=⅓, namely, P0−3×σ0=0, and a dotted line indicated by reference numeral 19 indicates σ0/P0=1, namely, P0−σ0=0.

Curves indicated by reference numerals 23, 22, 21, 20 represent cases of the helium flow rates of 10 L/m, 20 L/m, 50 L/m, and 70 L/m in the first example, respectively.

It is understood from FIG. 3 that, when the capacity of the pressure fluctuation absorbing container is made larger than that of the muffle tube, pressure fluctuations lower rapidly, and the pressure fluctuations become larger according to the reduction of the gas flow rate.

Symbols Δ and ◯ represent cases of the helium flow rates of 30 L/m and 70 L/m in the second example, respectively. When pressure control using the pressure control device 12 is not performed like the second example, the pressure fluctuation becomes larger than that in the case that the pressure control is performed. However, by attaching a pressure fluctuation absorbing container with a capacity larger than that of the muffle tube, the pressure fluctuation is lowered rapidly like the case that the pressure control is performed.

As described above, in the relationship between the pressure in the muffle tube and the pressure fluctuation where the pressure in the muffle tube does not lower to a negative pressure, which causes mixing of external air, P0−3×σ0>0 is established, namely, it is σ0<P0<⅓ in the vertical axis in FIG. 3. It can be assumed here that a desirable condition has been achieved when a curve of a graph is positioned below the straight line σ0/P0=⅓ indicated by reference numeral 18.

When the pressure fluctuation absorbing container is not attached, namely, in the case of “(pressure fluctuation absorbing container capacity+muffle tube capacity)/muffle tube capacity=1”, P0−3×σ0>0 is not satisfied in the curves 23 and 22 indicating the cases of the reduced gas flow rates (helium flow rates of 10 L/m and 20 L/m).

However, when the pressure fluctuation absorbing container is larger in capacity than the muffle tube, namely, in the case of “(pressure fluctuation absorbing container capacity+muffle tube capacity)/muffle tube capacity>2”, P0−3×60>0 is satisfied even in the case of the reduced gas flow rate, so that external air being mixed in the muffle tube due to a negative pressure can be prevented.

As described above, it is understood that, when the relationship between the gas flow rate and the capacity of the pressure fluctuation absorbing container that satisfies P0−3×σ0>0 is satisfied, the pressure in the muffle tube is always kept at a positive pressure so that mixing of external air in the muffle tube can be prevented. It is also understood that, when the pressure fluctuation absorbing container is larger in capacity than the muffle tube, P0−3×σ0>0 is easily satisfied, so that mixing of external air in the muffle tube can be prevented even when a flow rate of gas caused to flow in the muffle tube is reduced. It is desirable to increase the capacity of the fluctuation pressure absorbing container for suppressing the pressure fluctuation. However, since a large space around the installation needs to be secured according to the increase in capacity of the fluctuation pressure absorbing container, excessive increase in capacity is problematic. From the result of the present invention, it is understood that the capacity of the pressure fluctuation absorbing container up to five times the capacity of the muffle tube does not hinder the solution to the problems to be solved by the invention.

According to one aspect of the present invention, even if a flow rate of gas caused to flow in a muffle tube is low, external air can be prevented from being mixed into the muffle tube.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A method of dehydrating and sintering a porous preform for an optical fiber using a dehydration-sintering furnace that includes a muffle tube that accommodates therein the porous preform, a heater that heats the porous preform from outside of the muffle tube, and a furnace body that accommodates the heater at an outer periphery of the muffle tube, the method comprising:
supplying a gas required for dehydrating and sintering the porous preform in the muffle tube;
measuring a pressure in the muffle tube; and
controlling an average value of the pressure in the muffle tube P0 and a standard deviation of the pressure in the muffle tube σ0 so that a relation P0−3×σ0>0 is satisfied, wherein
a pressure fluctuation absorbing container is connected to the muffle tube,
a capacity of the pressure fluctuation absorbing container is larger than a capacity of the muffle tube,
the gas required for dehydrating and sintering is supplied from a lower portion of the muffle tube and exhausted from an upper portion of the muffle tube, and
a flow rate of the gas supplied from the lower portion is 10 liters per minute to 30 liters per minute.

2. The method according to claim 1, wherein the measuring the pressure in the muffle tube comprises intermittently measuring the pressure in the muffle tube at a set interval of time.

3. The method according to claim 2, wherein the set interval of time is 0.1 seconds.
